(19) United States
(12) Patent Application Publication
(10) Pub. No.: US 2005/0279450 A1
(43) Pub. Date: Dec. 22, 2005

(54) Method and apparatus for producing laminated products of infinite length

(76) Inventor: Kevin King, Orange, CA (US)

Correspondence Address: PEACOCK MYERS, P.C., 201 THIRD STREET, N.W., SUITE 1340, ALBUQUERQUE, NM, 87102, US

(21) Appl. No.: 10/869,803

(22) Filed: Jun. 16, 2004

(51) Int. Cl. B27D 1/00; B27G 11/00

(52) U.S. Cl. 156/304.1; 156/182; 156/299; 156/556

(57) ABSTRACT

A method and apparatus for producing endless (infinite length) lamination of elongated substrate pieces and elongated face layer pieces of random variable length.

### BACKGROUND OF THE INVENTION

Without limiting the scope of the present invention, this background relates to the production of laminated products, such as laminated flooring, in which at least one laminate layer or piece is of variable random length.

Aesthetically, many homeowners and business persons prefer hardwood flooring as opposed to other types of floor coverings such as carpeting, tile, stone, or the like. In particular, hardwood flooring has a color and texture and other highly prized features natural to the hardwood which cannot be synthetically duplicated. Another desired feature of hardwood flooring is the random length of planks which contribute to the natural appearance of real hardwood floors.

In recent years, particularly in light of environmental concerns for natural forestation, the price of hardwood lumber has increased significantly. In many cases, standard one (1) inch thickness (nominal) hardwood planks result in flooring costs that are unaffordable to the average consumer. In an effort to provide the desirable features of hardwood flooring while reducing the price of the hardwood material in a flooring plank or board, it has been found that boards may be laminated from a relatively thin top face layer of hardwood, a veneer of larger thickness, and a less expensive substrate layer which, in combination, approximates the standard thickness of flooring structurally required in the building industry. A desirable substrate may be common plywood which has many of the features desired in wooden flooring such as rigidity, strength, durability, etc.

In the United States, at this time, the lumber and building industry generally produces and uses plywood in a standard panel length and width; plywood panels in various thicknesses are available in a standard 8′×4′ form factor. Plywood panels are also available in other form factors, such as5′×10′. The term “plywood industry standard panel”. is intended to refer to the form factor prevailing at any point in time in the geographic location where the method or apparatus of the present invention is being performed or is located.

To create laminated planks, the plywood panels may be ripped along the long dimension in desirable widths. Since they are created from standard panels, the elongated plywood substrate pieces are of fixed length, for example, 8 feet or 10 feet. Current production of laminated hardwood flooring utilizing the fixed length substrate requires preparation of the face layer in pieces having a length corresponding to the fixed length of the substrate. However, natural hardwood lumber has no typical or standard width or length; the maximum length of hardwood is approximately 20 feet in today's market. In particular, the length of natural hardwood is variable and pieces or planks are of random length. Because laminated hardwood flooring desirably simulates natural hardwood flooring, one feature of which, as described above, is the random length, a more felicitous simulation would be achieved if the laminated hardwood flooring pieces were of random length rather than these identical, repetitive lengths of the standard substrate material. Greater simulation can be achieved if natural hardwood planks having a length of greater than 8 feet or 10 feet could be laminated so that the end or resulting laminated piece is equal to the length of the elongated hardwood face layer that is greater than the plywood industry standard panel of plywood.

For example, in the apparatus and method to be described, the length of a plywood panel currently is 10 feet and in the production of laminated hardwood flooring may be cut into widths, for example 3 inches, to simulate the width of a natural hardwood flooring plank. When laminated, the longest laminated piece of continuous face layer would be 10 feet. Of course, flooring installers can cut the 10 foot pieces into shorter lengths, and by staggering the lengths in adjacent rows, can give the appearance of random piece length natural flooring. But such simulation is limited by the length of the substrate and thus particularly in elongated building areas, such as large rooms or hallways, where it would be desirable to have flooring planks of length in excess of 10 feet, the laminated hardwood flooring cannot fully simulate the natural hardwood flooring with its desirable aesthetic features. It may also be desirable to use substrate material of variable length permitting the manufacturer to purchase the lowest cost substrate.

It is therefore an object of the present invention to provide a method and apparatus that permits the manufacture of laminated hardwood flooring that more closely approximates or simulates the more expensive natural hardwood flooring.

There are various prior art patents which disclose methods and apparatus for producing laminated veneer panels or joists, including U.S. Pat. No. 6,444,079 (Bielfeldt); U.S. Pat. No. 6,280,560 (Graf); U.S. Pat. No. 5,895,546 (Bielfeldt); U.S. Pat. No. 5,942,079 (Bielfeldt); U.S. Pat. No. 6,007,677 (Skuse); U.S. Pat. No. 3,841,945 (Troutner); U.S. Pat. No. 3,686,061 (Brown); U.S. Pat. No. 4,640,857 (Hasegawa); and U.S. Pat. No. 3,963,552 (Troutner).

### BRIEF SUMMARY OF THE INVENTION

It is an object of this invention to provide a method for producing laminated material comprised of elongated pieces, at least one piece of which has significantly higher value content than the other piece and provides a desired aesthetic appearance and is therefore referred to as the “face layer”. The laminate comprises at least one other layer, referred to as the “substrate”, and which generally has a lower value content than the face layer and generally, but not necessarily, provides more of the structural integrity of the laminated material.

The present invention provides a method that comprises steps of continuously feeding two elongated pieces along two adjacent but separate longitudinal paths. Glue is applied to one surface of at least one of the pieces, after which the two pieces converge so as to overlay one piece on the other. A contact force may be applied as required to permit the glue to set, i.e., to cure sufficiently such that the laminated piece has integrity. The method may be used for laminating substrate layers comprising pieces of fixed or random, variable lengths and a face layer comprising pieces of random, variable, lengths. The continuous feeding process involves feeding successive substrate pieces in end-abutting relationship and similarly feeding elongated face layer pieces with a biasing force so as to maintain an end-abutting relationship. The result of the method is to create an infinitely long or endless laminated material that may be cut in random lengths corresponding to the random length of the face layer pieces.

The method can advantageously be used in the production of laminated flooring in which the substrate pieces are of a fixed variable length and the face layer pieces are natural hardwood of random variable length whereby upon completion of the lamination the infinitely long laminated flooring may be cut in random lengths corresponding to the random length of the hardwood face layer.

The apparatus of the present invention performs the above-described method and comprises four stations or modules including a substrate piece feeding station, a face layer piece feeding station, a gluing station, and a contact station in which variable random length face layer pieces are joined to fix or variable length substrate pieces forming a continuous lamination that may be cut in random lengths.

### DETAILED DESCRIPTION OF THE DRAWINGS

The present invention may be better understood by referring to the following description on conjunction with the accompanying drawings, in which:

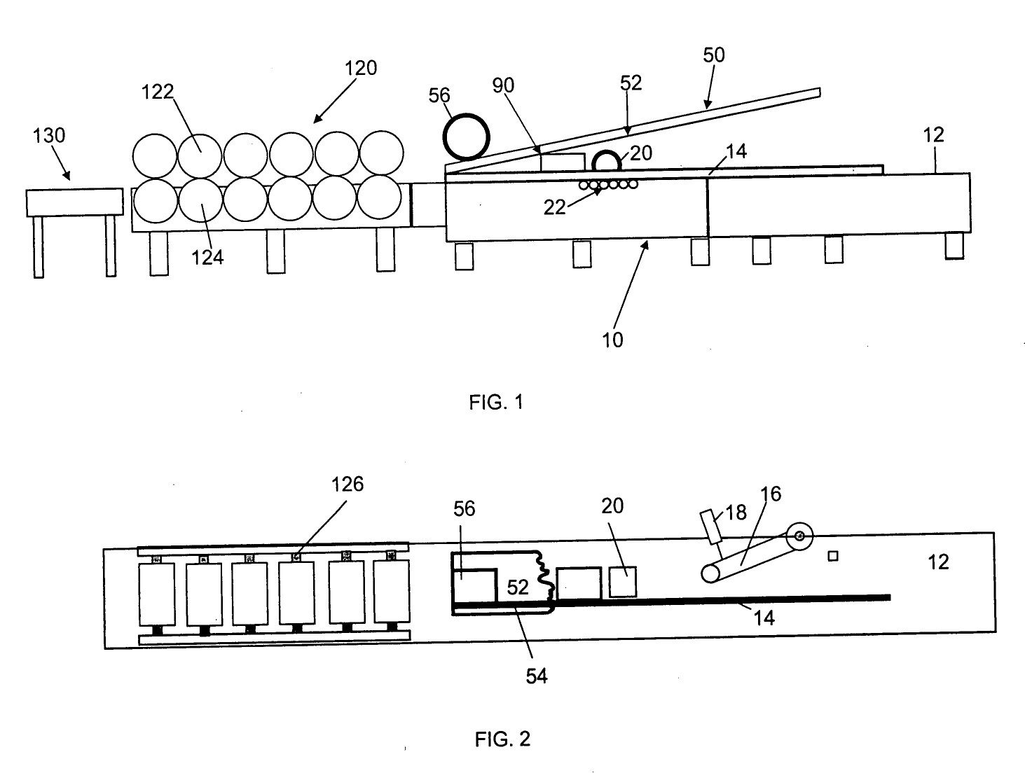

FIG. 1 is a schematic illustration of one embodiment of the apparatus of the present invention showing the stations or modules;

FIG. 2 is a top diagrammatic view of the apparatus shown in FIG. 1;

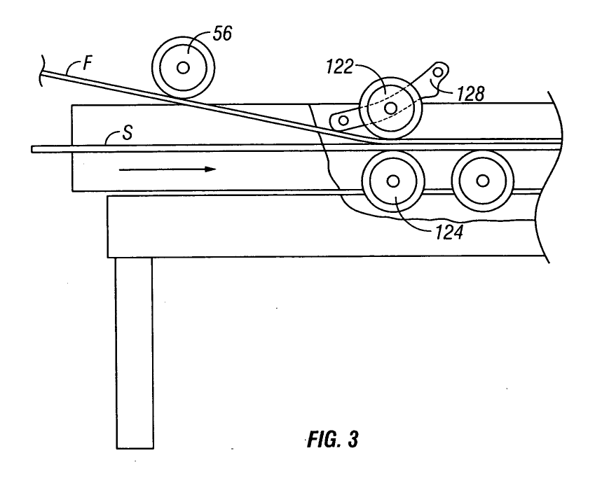

FIG. 3 is a more detailed diagrammatic view of one portion of the apparatus shown in FIG. 1;

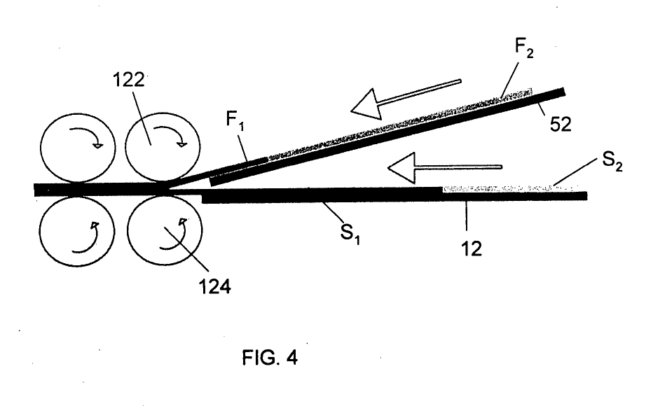

FIG. 4 is a diagrammatic view showing a portion of the apparatus in which the pieces are overlaid or joined; and

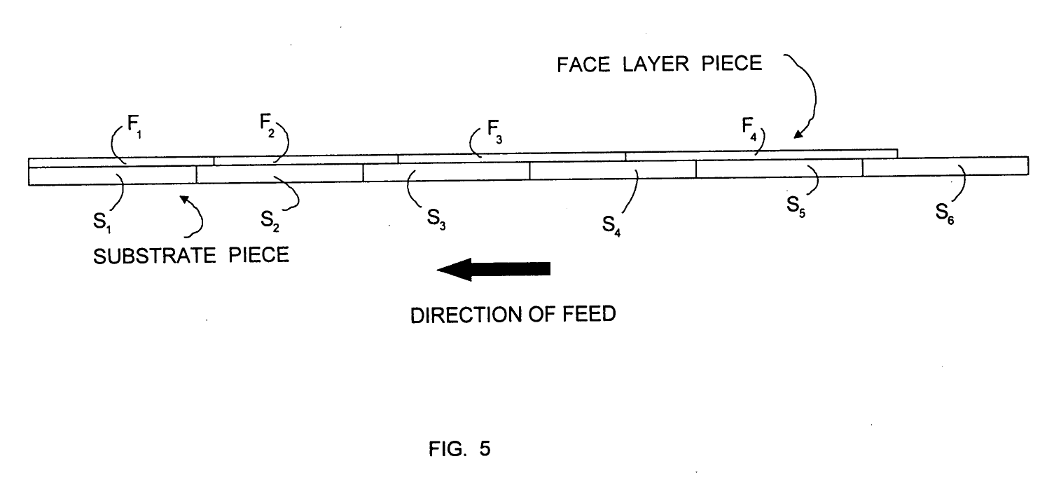

FIG. 5 is an illustration of the lamination produced by the apparatus and method of the present invention.

### DETAILED DESCRIPTION OF THE INVENTION

Referring now to FIG. 1, there is shown schematically or diagrammatically one embodiment of the apparatus of the present invention. Generally, the apparatus has four modules or stations: a continuous feed module 10 for longitudinally moving substrate pieces; a continuous feed module 50 for moving face layer pieces along their longitudinal axes; a gluing location or station 90; and an overlay or compression module 120. The invention may additionally comprise a saw module for cutting the continuous laminate into pieces of desired length. The substrate piece continuous feed module comprises a generally horizontal planar table 12 on which elongated pieces of substrate material may be manually placed. It should be understood that the feed module may include an automatic pick-and-place sub-assembly for feeding the substrate piece, such sub-assemblies being known to those of ordinary skill in the art. The substrate pieces are aligned for subsequent lamination by sidewall 14 mounted on table 12. The substrate pieces are maintained against sidewall 14 by a sub-assembly including a pivotal arm 16 that is biased toward the sidewall 14 by hydraulic, pneumatic, or mechanical spring device 18 so that the free end of pivot arm 16 will bear against the side edge of the substrate piece and force the substrate piece against sidewall 14 which is generally aligned with the longitudinal axis of the entire apparatus. The substrate piece is moved forward along its axis (to the left as viewed in FIGS. 1 and 2) until the drive wheel 20 mounted above table 12 (at a height sufficient to allow the substrate piece to pass underneath) catches or grasps the forward end of the piece. Wheel 30 is biased downwardly such that its surface, preferably provided with a high friction layer, will drive the substrate piece forward. To facilitate this action, a series of rollers 22 may be mounted below table 12 such that the upper tangential surface of each roller is generally in the plane of table 12 and facilitates the movement of the substrate piece forward.

Another feed module 50 is provided for the face layer pieces which may be up to twenty feet or longer in length. As with the substrate module 10, the face layer pieces may be manually or automatically positioned on an inclined platform 52 located above feed module 10 and having a side wall 54 that is laterally aligned with side wall 14 of table 12 of the continuous feed module for substrate pieces. The plane of feed table 52 is inclined to the plane of table 12 so that face layer pieces on table 52, when moved forward, will coverage with and overlay substrate pieces as seen best in FIG. 4. The incline is preferably kept at as low an angle as possible preferably less than 30° and more preferably less than 20°, to prevent too severe a bend in the top face layer as it enters the rollers. (See FIG. 1) The face layer piece is driven forward by drive wheel 56 which also has a high friction surface and is mounted so as to be biased perpendicular to the plane of table 52 so as to apply a force to the upper surface of the face layer piece and thereby drives the face layer piece forward. The drive wheel is canted approximately 3° so that the wheel also biases the face layer piece against side wall 54 so that it is aligned with the substrate piece.

The third station or module 90 of the apparatus is a gluing station that applies glue to the upper surface of the substrate piece that passes below the glue dispenser. It will be understood by those of skill in the art that a wide variety of glue or adhesives may be used in the lamination process of the present invention depending upon the types of materials that are being laminated, and a plurality of other factors considered by those of skill in the art such as viscosity, composition, set time, cure time, pressure applied to the pieces to be glued, environmental conditions such as temperature and humidity, and the speed at which the continuous feed line is operated. A glue formulation that has been found suitable for wood plank laminations is Dura-PUR UH-2043 LV Purple manufactured and sold by IFS Industries that is applied at a temperature of 300° F. It will also be understood that glue may be applied to one or both mating surfaces of the substrate and face layer pieces as determined by the process parameters and the type of glue employed. As also well known to those in the art, it may be desirable to preheat the pieces to be laminated using microwave/high frequency heating or convection/radiant heating, all in accordance with the type of adhesive employed. It is also well known that if the face layer and substrate layers are wood, the type of glue may also be required to account for the moisture content of the wood pieces.

The next module or station 120 of the apparatus of the present embodiment comprises a series of rollers for compressing the overlayed face layer piece and substrate piece so as to form the lamination. Solely by way of example, the compression module 120 may have multiple pairs of compression rollers 122, 124 mounted on suitable axles 126. While six pairs of rollers are shown, this is solely exemplary and a single pair, or in excess of six pairs of rollers may be employed. The number of rollers, in addition to other factors, will depend upon the set or cure time of the adhesive used. In the diagrammatic embodiment shown, the bottom rollers, such as roller 124, are mounted for powered rotation so as to advance the face layer pieces and the substrate pieces after they are overlaid due to the converging axis of the first and second continuous feed modules. The upper rollers, such as roller 122, is a drive roller and as seen best in FIG. 3 it is pivotally mounted on arm 128 and is biased toward lower roller 124. The biasing force may be pressure-regulated air flow applied through pistons or an air bag applied to all of the biasing rollers 122. Rollers 122 may be provided with a high friction surface so as to engage the upper face layer piece and drive it forward. Rollers 124 may be idler rollers or may also be driven.

The relationship between the rotational speed of the compression rollers 122, 124 and the continuous feed rollers 20 and 56 is important in achieving the end result of the invention. To achieve structural integrity in the laminate, it is important that the ends of successive pieces of the face layer as well as successive pieces of the substrate layer be continuously engaged so that no gap appears between successive pieces. This is accomplished by driving the continuous feed wheels 56 and 20 at a rotational speed such that the tangential lineal speed imparted to the engaged piece is in excess of the speed of the compression rollers 122, 124. The compression rollers “pull” the laminate pieces through the rollers and determine the overall lineal speed of the apparatus which may be on the order of 40 feet/sec. Prior to entering the rollers, each piece “pushes” the preceding piece forward at a speed that exceeds the roller speed thereby assuring a continuous end-abutting relationship. Since the lineal speed of the pieces in the continuous feed stations or modules of the invention is in excess of the lineal speed imparted by the compression rollers 122, 124, for example, twice the tangential speed of the rollers, the drive wheels 56, 20 may be provided with a suitable clutch, or may simply slightly slip so as to impart a forward motion.

The converging portion of the apparatus, between the two continuous feed modules and the compression module, is shown in FIG. 4. It will there be seen that the drive rollers 122, 124 are positioned longitudinally adjacent to the end of table 52 of the continuous feed modules for the face layer pieces 50 and the generally horizontal continuous feed module table 12. This converging section shows four laminate pieces or sections at the point of convergence. The substrate pieces are identified as S₁ and S₂ and the face layer pieces are designated as F₁ and F₂. Attention is drawn to the fact that successive pieces F₁, F₂ are end-abutted with no gap there between. Similarly, substrate pieces S₁ and S₂ are end-abutted. It will also be noted that the trailing edge of piece F₁ is advanced relative to the trailing edge of substrate piece S₁ such that the abutting edges of pieces F₁, F₂ will be laminated to an intermediate portion of substrate S₁.

For purposes of illustration of the end product of the apparatus, there is shown in FIG. 5 a portion of an endless or infinite length lamination formed from substrate and face layer pieces. In an application of the apparatus for manufacturing wooden flooring, where the face layer is a hardwood and the substrate is fabricated from plywood panels, the substrate pieces are elongated pieces of uniform length. This uniform length results from use of plywood industry standard panels, which at the present time in the United States, are 8 feet in length. Thus each substrate piece S₁ through S₆ is of identical length. However, the method and apparatus may use substrate pieces of variable length, i.e., each batch of substrate pieces may be of fixed length, but the length is not the same as the length in a prior or subsequent batch, or, within a batch each piece may be of random, variable length. The face layer pieces, resulting from the selection of hardwood lumber that is milled so as to maximize the length of each plank or board results in elongated face layer pieces of random variable length. In FIG. 5, each of the face layer pieces F₁ through F₄ have a length greater than the fixed length of substrate pieces S₁ through S₆. It will be appreciated that in order to achieve the aesthetic effect of natural hardwood lumber, rather than a laminate, the endless lamination may be sawn at the juncture of succeeding face layer pieces, for example, between F₁ and F₂, between F₃ and F₄, etc. Thus the resulting flooring pieces will have variable lengths such as shown in the example of F₁ through F₅ all of which are variable in length. A cut-off saw for sawing the lamination at the junctures as described above utilizes a saw blade assembly that is linearly moveable so as to reach the speed of the moving laminate and then move transversely so as to sever the lamination at the juncture, as is well known in the art. The cut-off saw may determine the location of the junctures by appropriate sensors, or may employ markings at the junctures, e.g., by chalk, that is sensed by an optical reading device.

The method of the present invention comprises the steps of feeding the elongated substrate pieces continuously such that a first piece is followed by a second substrate piece with a biasing force exerted against the first piece so as to maintain successive pieces in end-abutting relationship. Simultaneously, elongated face layer pieces including a first layer piece is fed along a path that will converge with the path of the fixed length substrate piece feed and a second face layer piece is fed so as to be biased against the first piece so as to maintain the successive face layer pieces in end-abutting relation. These steps as described for the first and second piece is repeated so as to continuously feed face layer and substrate pieces. The method additionally includes the application of glue or adhesive to at least one of the mating surfaces of the elongated pieces. After glue application, the first face layer piece is overlayed on the first substrate piece to thereby form a lamination as desired. The endless lamination may then be cut into random lengths corresponding to the random length of the face layer pieces, or may be cut to a selected fixed length and later processed by cutting the fixed length pieces to random lengths corresponding to the random length of the face layer pieces.

As noted above, the apparatus and method of the present invention are applicable to the production of an endless laminate, particularly where one layer, ply, or piece of the lamination is a relatively high value material which has desirable aesthetic qualities. This face layer piece may be a thin ply of sufficient thickness to form a durable long-lasting but aesthetically pleasing upper surface. An example of such high value material may be hardwood for use in hardwood flooring, but may be other materials than wood. The substrate layer provides more of the structural integrity of the lamination but is cheaper and has a lesser aesthetic appeal. In the flooring example, it may comprise a ¾ inch thick piece of plywood that has been ripped from a standard 4×8 foot plywood panel. Other types of substrate material than wood or plywood may be employed for the thicker strength member of the lamination. For example, the substrate may be plastic, fiberglass, wood composite, Aluminum, or other metal. The face layer may also be a material other than hardwood including plastic, metal or other decorative material.

Although a preferred embodiment of the invention has been described in detail, it would be understood by those skilled in the art that there various modifications can be made to the apparatus and method without departing from the spirit and scope of the invention as set forth in the appended claims.

1. A method for producing endless laminated flooring from a plurality of elongated substrate pieces and a plurality of elongated face layer pieces of random variable length, comprising
feeding elongated substrate pieces including a first piece;
feeding a second substrate piece with a biasing force exerted against the first piece so as to maintain the successive substrate pieces in end-abutting relation;
continuing to feed additional successive substrate pieces in end-abutting relationship;
feeding elongated face layer pieces including a first face layer piece;
feeding a second face layer piece with a biasing force exerted against the first face layer piece so as to maintain the successive face layer pieces in end-abutting relation;
continuing to feed additional successive face layer pieces in end-abutting relationship;
applying glue to at least one mating surface of said elongated pieces; and
overlaying the first face layer piece on the first substrate piece to thereby laminate the substrate and face layer pieces and continuing to overlay successive pieces to create infinitely long laminated flooring that may be cut in random lengths corresponding to the random length of the face layer pieces.

2. The method of claim 1 wherein said face layer pieces are natural hardwood.

3. The method of claim 2 wherein the substrate pieces are plywood.

4. The method of claim 3 wherein all said substrate pieces are approximately equal in length.

5. The method of claim 4 wherein the length of the substrate pieces is the plywood industry standard panel length dimension.

6. The method of claim 5 wherein the typical face layer piece length is greater than the plywood industry standard panel length.

7. The method of claim 1 wherein the step of overlaying includes the step of applying a contact force to said overlaid face layer piece and substrate piece.

8. The method of claim 7 wherein said contact force is maintained until said glue is set.

9. The method of claim 8 wherein said contact force is applied by a series of rollers.

10. The method of claim 9 wherein said rollers are positioned in pairs in contact with opposite exterior surfaces of said face layer and substrate pieces and are biased toward one another.

11. The method of claim 1 wherein the first face layer piece, when fed, is longitudinally offset from the forward edge of the first substrate piece.

12. A method for producing laminated material of infinite length from a plurality of elongated substrate pieces and a plurality of elongated face layer pieces of random variable length, comprising:
continuously moving the elongated substrate pieces along a longitudinal axis in a substrate moving plane;
continuously moving additional substrate pieces with a biasing force exerted against a preceding piece so as to maintain the successive piece in end abutting relation to the preceding piece;
continuously moving elongated face layer pieces along the longitudinal axis in a plane that is inclined in relation to said substrate moving plane;
continuously moving additional face layer pieces with a biasing force exerted against the preceding piece so as to maintain successive pieces in end abutting relation;
applying glue to at least one mating surface of said elongated pieces; and
overlaying the face layer pieces on the substrate pieces to thereby laminate the face layer pieces and substrate pieces to create an endless lamination.

13. The method of claim 12 wherein all said substrate pieces are approximately in equal length.

14. The method of claim 12 wherein the step of overlaying includes the step of applying a contact force to said face layer and substrate pieces.

15. The method of claim 14 wherein said contact force is maintained until said glue is set.

16. The method of claim 15 wherein said contact force is applied by a series of rollers.

17. The method of claim 16 wherein said rollers are positioned in pairs in contact with opposite exterior surfaces of said face layer and substrate pieces and are biased toward one another.

18. The method of claim 12 wherein said face layer plane is inclined to said substrate plane at an angle less than 30°.

19. The method of claim 12 wherein continuously moving both the substrate and face layer pieces so as to maintain abutting relationship is through drive wheels that have a tangential speed greater than the tangential speed of said rollers.

20. An apparatus for producing laminated material of infinite length from a plurality of elongated fixed length substrate pieces and a plurality of elongated face layer pieces of random variable length, comprising
a continuous feed module for said substrate pieces;
a continuous feed module for said face layer pieces;
each of said continuous feed modules feeding successive pieces in end-abutting relationship;
a glue station applying glue to one surface of at least one of said pieces;
said continuous feed modules arranged so as to direct said substrate pieces and said face layer pieces into longitudinal contact; and
a compression module that forces said face layer pieces and said substrate pieces into firm contact until the glue at least partially cures.

21. The apparatus of claim 20 additionally including a module cutting the laminated material at the randomly occurring junction of abutting face layer pieces.

22. The apparatus of claim 21 wherein the face layer material is natural hardwood lumber.

23. The apparatus of claim 22 wherein said continuous feed modules include at least one drive wheel provided with a friction surface.

24. The apparatus of claim 23 wherein said compression module comprises at least one pair of rollers between which the laminated material passes, the rollers being biased toward one another, and at least one of the rollers driving the laminated material.

25. The apparatus of claim 24 wherein said continuous feed module driving wheel has a rotational speed greater than the rotational speed of said pair of compression rollers.

26. The apparatus of claim 21 wherein said face layer piece material has a high monetary value relative to the substrate material value.

27. The apparatus of claim 22 wherein said substrate piece material is plywood.

30. An apparatus for producing endless laminated flooring from a plurality of elongated substrate pieces and a plurality of elongated face layer pieces of random variable length, comprising
a first continuous feed module for said substrate pieces disposed in a substantially horizontal plane;
a second continuous feed module for said face layer pieces, disposed above said first continuous feed module and inclined at an angle to said first continuous feed module so that the substrate pieces and face layer pieces converge so that said face layer pieces are overlaid on said substrate pieces;
a glue station applying glue to one surface of at least one of said pieces prior to overlaying the face layer pieces on the substrate pieces; and
a station that compresses the face layer pieces and substrate pieces into contact as the pieces are fed through said compression station.
